(19) United States
(12) Patent Application Publication
(10) Pub. No.: US 2018/0231651 A1
(43) Pub. Date: Aug. 16, 2018

(54) MICROWAVE RADAR SYSTEM ON A SUBSTRATE

(71) Applicant: Humatics Corporation, Cambridge, MA (US)

(72) Inventor: Gregory L. Charvat, Guilford, CT (US)

(73) Assignee: Humatics Corporation, Cambridge, MA (US)

(21) Appl. No.: 15/347,534

(22) Filed: Nov. 9, 2016

Related U.S. Application Data
(60) Provisional application No. 62/253,983, filed on Nov. 11, 2015.
(60) Provisional application No. 62/268,745, filed on Dec. 17, 2015.
(60) Provisional application No. 62/306,483, filed on Mar. 10, 2016.

(51) Int. Cl. G01S 13/32; G01S 13/93; G01S 7/282; G01S 7/288; G01B 11/14

(52) U.S. Cl. CPC G01S 13/325; G01S 13/931; G01B 11/14; G01S 7/288; G01S 7/282

(57) ABSTRACT

An apparatus, comprising a substrate, a plurality of microwave radio-frequency (RF) transceiver units coupled to the substrate; and a focusing element mounted on the substrate and configured to focus microwave RF signals generated by the plurality microwave RF transceiver units. The focusing element may comprise a reflector or a lens.

### CROSS REFERENCE TO RELATED APPLICATIONS

This application claims the benefit under 35 U.S.C. § 119 to U.S. Provisional Application Ser. No. 62/253,983, titled “RADAR AND ANTENNA SYSTEM ON A SUBSTRATE,” filed on Nov. 11, 2015; U.S. Provisional Application Ser. No. 62/268,745, titled “RADAR ON A CHIP,” filed on Dec. 17, 2015; and U.S. Provisional Application Ser. No. 62/306,483, titled “HIGH-PRECISION TIME OF FLIGHT MEASUREMENT SYSTEM ON A CHIP,” filed on Mar. 10, 2016, each of which is incorporated by reference herein.

### BACKGROUND

A collision avoidance system may be installed on a vehicle, such as a car, to warn the operator of the vehicle that there are one or more objects in the path of the vehicle and that a collision may occur. In response to such a warning, the operator of the vehicle may perform one or more actions to avoid the collision. For example, the operator may change the speed at which the vehicle is traveling (e.g., by applying brakes) or the direction in which the vehicle is traveling (e.g., by turning the steering wheel).

Conventional collision avoidance systems include one or more sensors to detect whether there are any objects in the path of the vehicle. Such sensors include radar sensors, optical sensors (e.g. a camera), and lasers.

### SUMMARY

Some embodiments provide for an apparatus, comprising: a substrate; a plurality of microwave radio-frequency (RF) transceiver units coupled to the substrate; and a focusing element mounted on the substrate and configured to focus microwave RF signals generated by the plurality microwave RF transceiver units. The focusing element may comprise a reflector or a lens.

Some embodiments provide for an apparatus, comprising: a substrate; a plurality of radio-frequency (RF) transceiver units coupled to the substrate; and a reflector mounted on the substrate and configured to focus microwave RF signals generated by the plurality microwave RF transceiver units.

The foregoing is a non-limiting summary of the invention, which is defined by the attached claims.

### BRIEF DESCRIPTION OF DRAWINGS

Various aspects and embodiments will be described with reference to the following figures. It should be appreciated that the figures are not necessarily drawn to scale.

FIG. 1A is a top view of an illustrative microwave radar system on a substrate, in accordance with some embodiments of the technology described herein.

FIG. 1B is a side view of the illustrative microwave radar system on a substrate shown in FIG. 1A, in accordance with some embodiments of the technology described herein.

FIG. 1C is a side view of another illustrative microwave radar system on a substrate, in accordance with some embodiments of the technology described herein.

FIG. 1D is a side view of another illustrative microwave radar system on a substrate, in accordance with some embodiments of the technology described herein.

FIG. 1E illustrates RF beams that may be generated by a microwave radar system on a substrate, in accordance with some embodiments of the technology described herein.

FIG. 1F is a top view of another illustrative microwave radar system on a substrate, in accordance with some embodiments of the technology described herein.

FIG. 1G is an illustration of a microwave radar system on a substrate that includes a concave auxiliary reflector, in accordance with some embodiments of the technology described herein.

FIG. 1H is an illustration of a microwave radar system on a substrate that includes a convex auxiliary reflector, in accordance with some embodiments of the technology described herein.

FIG. 2A is a block diagram of microwave radio-frequency (RF) transceiver units disposed on a substrate, in accordance with some embodiments of the technology described herein.

FIG. 2B is another block diagram of microwave radio-frequency (RF) transceiver units disposed on a substrate, in accordance with some embodiments of the technology described herein.

FIG. 3 is a block diagram of transmit/receive circuitry part of a microwave radio-frequency (RF) transceiver unit in a microwave radar system on a substrate, in accordance with some embodiments of the technology described herein.

### DETAILED DESCRIPTION

The inventors have recognized that conventional collision avoidance systems can be improved upon because they are expensive to manufacture and resource-intensive to operate. For example, conventional radar systems scan areas of interest by operating a collection of RF transmit antennas in a phase coherent manner—the RF beam is generated by setting the relative phases of the signals feeding the RF transmit antennas so that the effective radiation pattern of the transmit antennas is reinforced in the desired direction. However, the circuitry required for implementing phase coherence among the RF transmit antennas is very expensive (tens or hundreds of thousands of dollars and higher)—the cost is prohibitively expensive for non-military applications such as collision avoidance for cars, low-cost UAVs, and/or other vehicles. As another example, optical collision avoidance systems require a significant amount of power to operate and, for this reason, are impractical to install on platforms (e.g., UAVs) where power is a scarce resource.

The inventors have developed a low-cost microwave radar system on a substrate, which may be used for a variety of applications including collision avoidance. Due to its low-cost and small size, the microwave radar system on a substrate may be installed on any of a variety of vehicles including cars and unmanned aerial vehicles such as drones. The microwave radar system developed by the inventors may use less power than conventional optical collision avoidance systems. For example, in some embodiments, each of the RF transmitters in the radar system radiate 5-10 mW of RF transmit power. Moreover, the microwave radar system on a substrate developed by the inventors may be significantly cheaper than conventional radar systems because, unlike conventional radar systems, the RF transmitters are not operated in a phase coherent manner. As a result, expensive phase-coherence circuitry need not be included. Instead of relying on phase coherence to achieve beam steering, the microwave radar system generates RF beams pointing in different directions by utilizing a focusing element, such as a reflector or lens, to focus the RF energy from each RF transmitter into a corresponding direction, as described below.

Some embodiments described herein address all of the above-described issues that the inventors have recognized with conventional collision avoidance systems. However, not every embodiment described herein addresses every one of these issues, and some embodiments may not address any of them. As such, it should be appreciated that embodiments of the technology described herein are not limited to addressing all or any of the above-discussed issues of conventional collision avoidance systems.

Accordingly, some embodiments provide for a microwave radar system on a substrate that includes: (1) a substrate (e.g., a printed circuit board); (2) multiple microwave RF transceiver units coupled to the substrate; and (3) a focusing element (e.g., a reflector or a lens). The multiple microwave RF transceiver units may be operated in a one-at-a-time manner to transmit RF signals toward the focusing element, which in turn focuses the RF signals into RF beams that may be used to scan an area of interest such as, for example, an area at a distance of interest in front of a vehicle.

In some embodiments, each of the multiple RF transceiver units may include one or more transmit antennas configured to transmit microwave RF signals, one or more receive antennas configured to receive microwave RF signals, and transceiver circuitry. The transceiver circuitry may include transmit circuitry configured to generate and provide, to the transmit antenna(s), RF signals to be transmitted by the transmit antenna(s). The transceiver circuitry may also include receive circuitry configured to receive, from the receive antenna(s), microwave RF signals detected by the receive antenna(s).

In some embodiments, each of the multiple RF transceiver units may have some or all components (e.g., one or more antennas, transceiver circuitry) integrated on a semiconductor die. For example, in some embodiments, the transceiver circuitry may be integrated on the semiconductor die. As another example, the transmit and receive antennas and the transceiver circuitry all may be integrated on the same single semiconductor die.

In some embodiments, the microwave system on a substrate further includes a controller configured to control the multiple RF transceiver units to operate one-at-a-time according to a schedule. The controller may be mounted on the substrate.

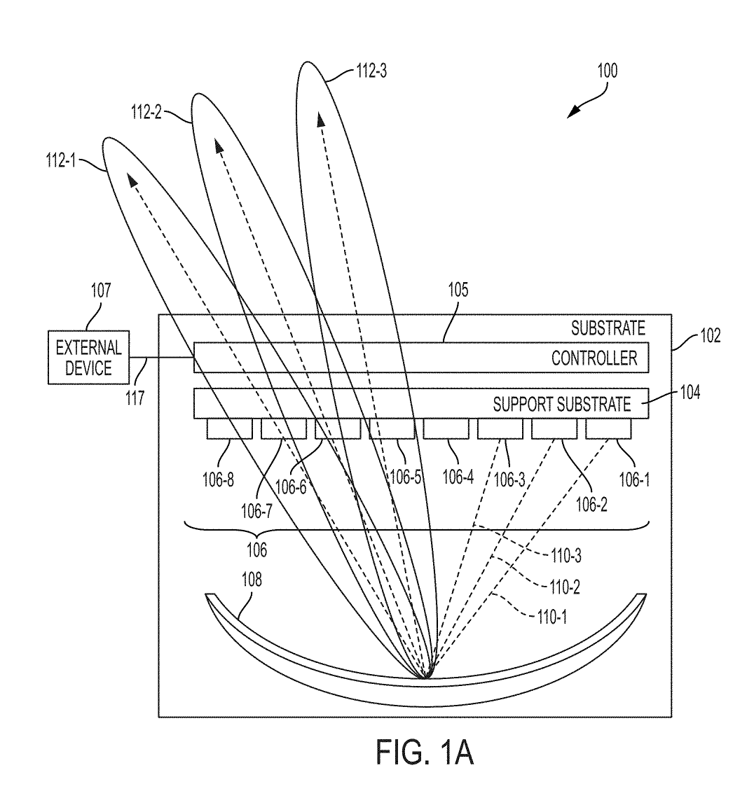

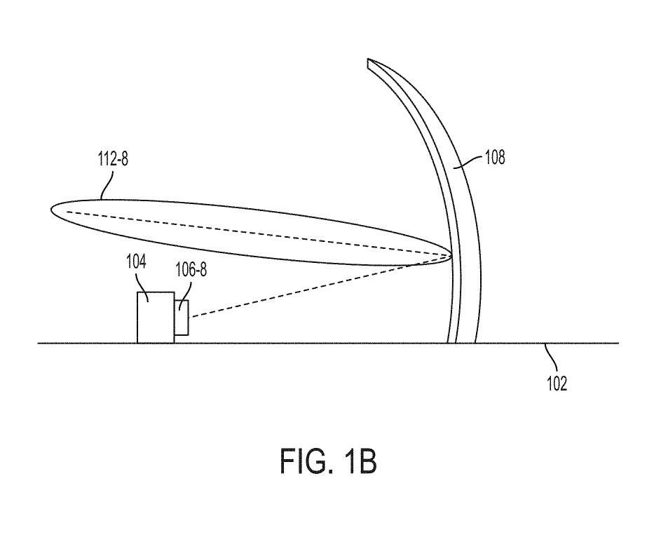

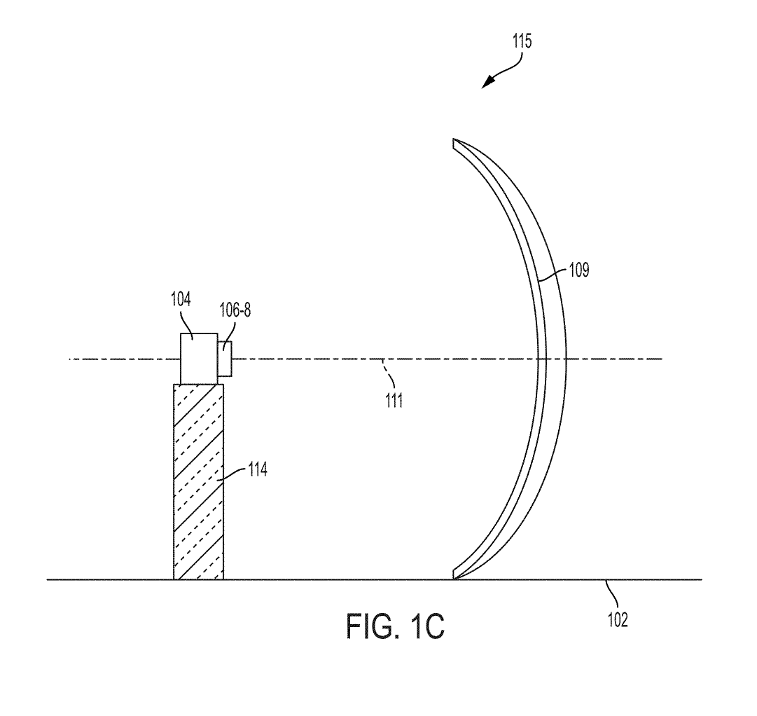

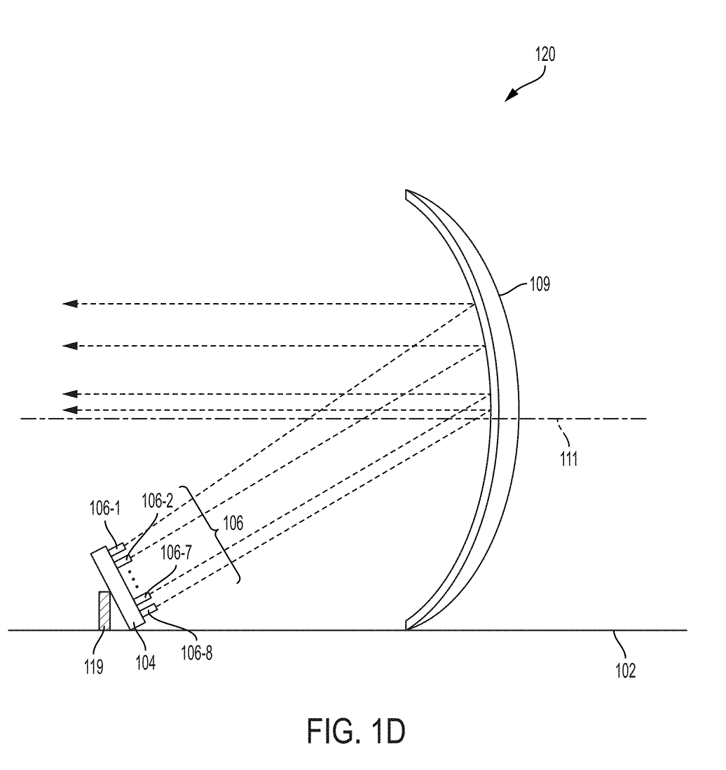

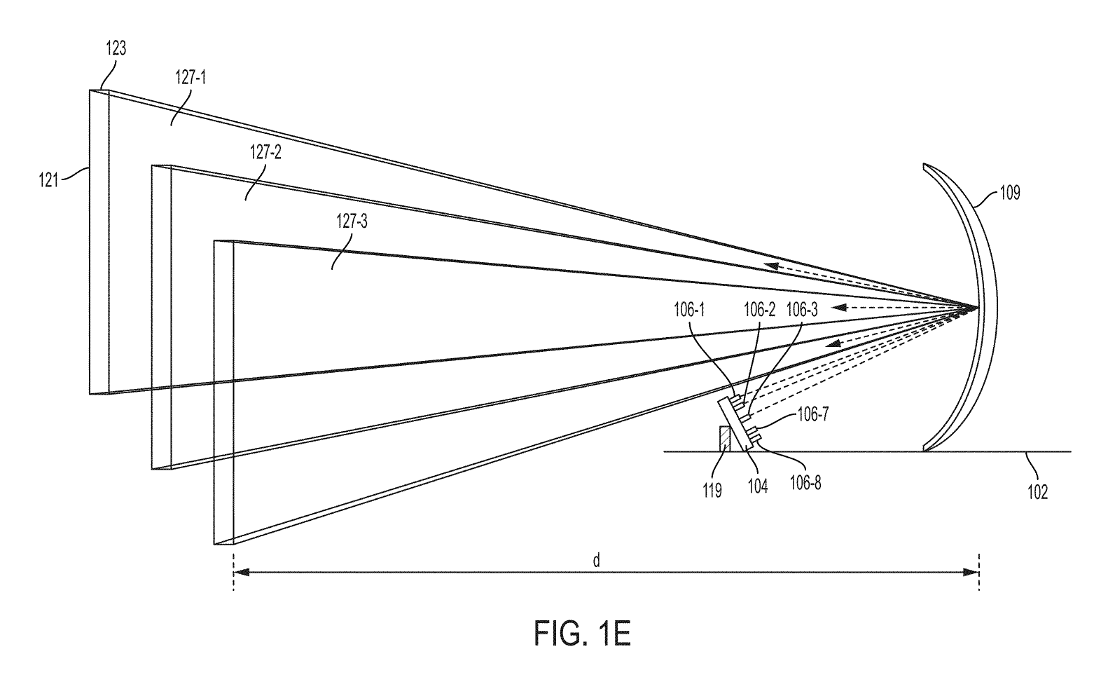

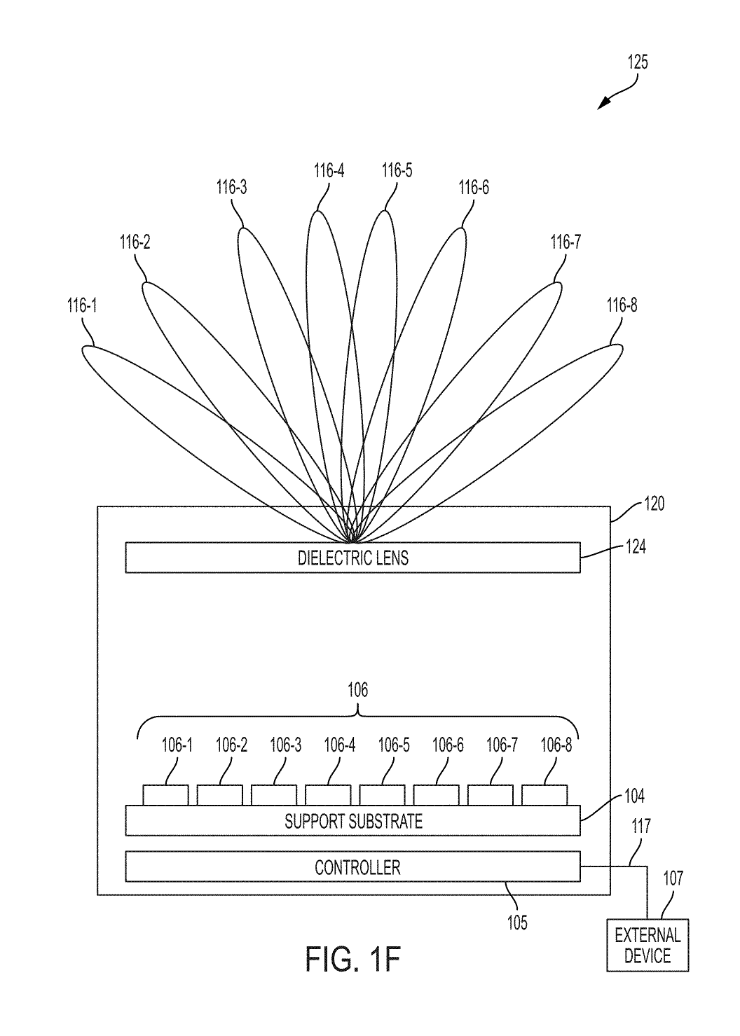

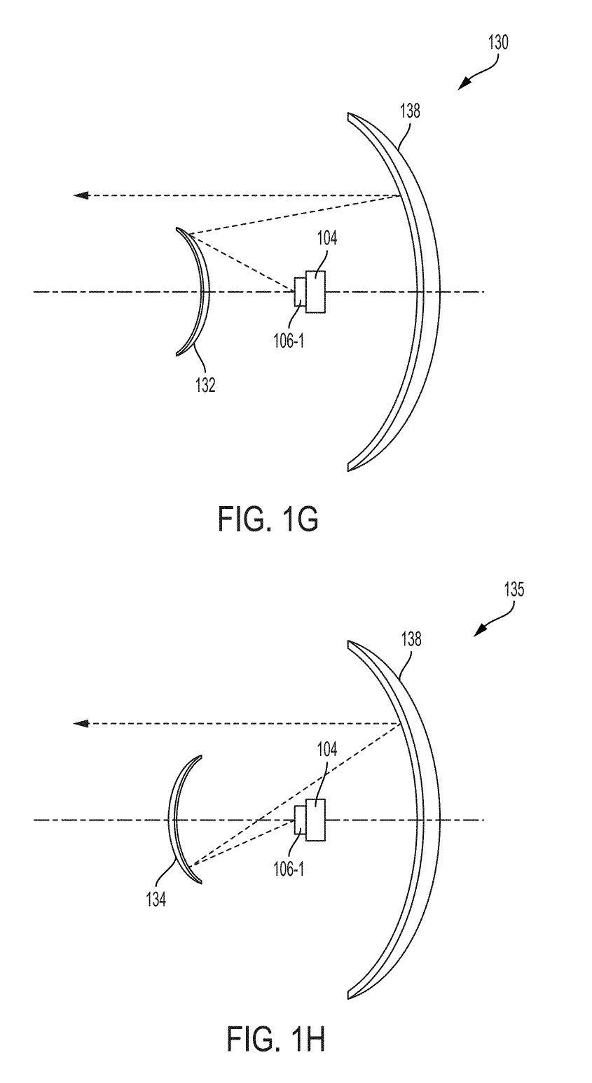

In some embodiments, in response to receiving an RF signal from one of the plurality of microwave RF transceivers, the focusing element is configured to generate an RF beam having a greater extent in elevation than in azimuth, for example, as illustrated in FIG. 1E. Such an oblong beam may be used in collision avoidance applications (e.g., to reliably detect power lines in front of a UAV).

It should be appreciated that the techniques introduced above and discussed in greater detail below may be implemented in any of numerous ways, as the techniques are not limited to any particular manner of implementation. Examples of details of implementation are provided herein solely for illustrative purposes. Furthermore, the techniques disclosed herein may be used individually or in any suitable combination, as aspects of the technology described herein are not limited to the use of any particular technique or combination of techniques.

FIG. 1A is a top view of an illustrative microwave radar system 100 on a substrate, in accordance with some embodiments of the technology described herein. The microwave radar system 100 comprises a substrate 102. As shown in FIG. 1A, support substrate 104, controller 105, and focusing element 108 are each disposed on the substrate 102. Substrate 102 may be of any suitable type and, for example, may comprise a printed circuit board (PCB). Support substrate 104 also may be of any suitable type and may comprise a PCB. Controller 105 is coupled to external device 109 via connection 107, which may be a wired or wireless connection.

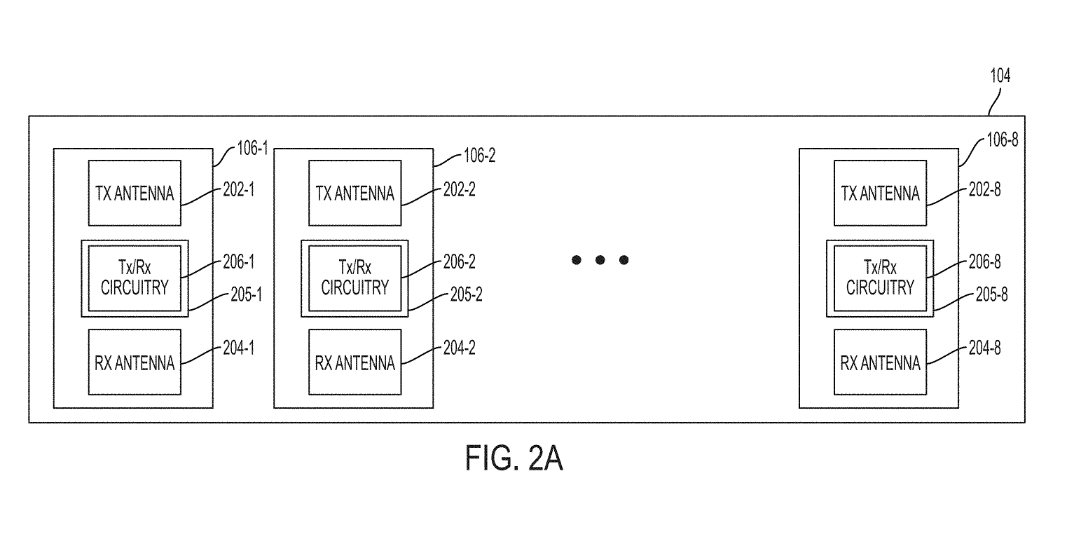

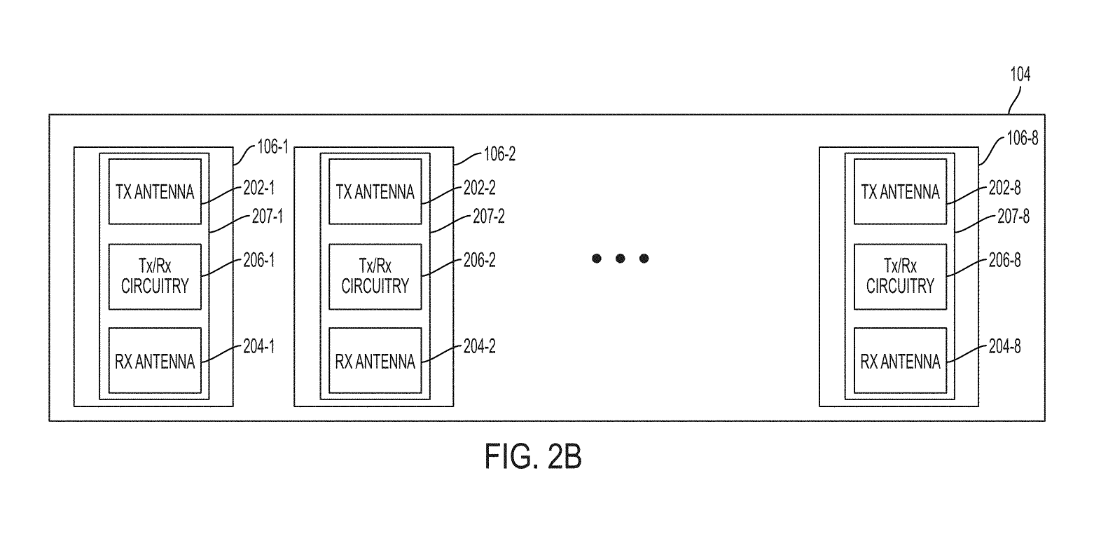

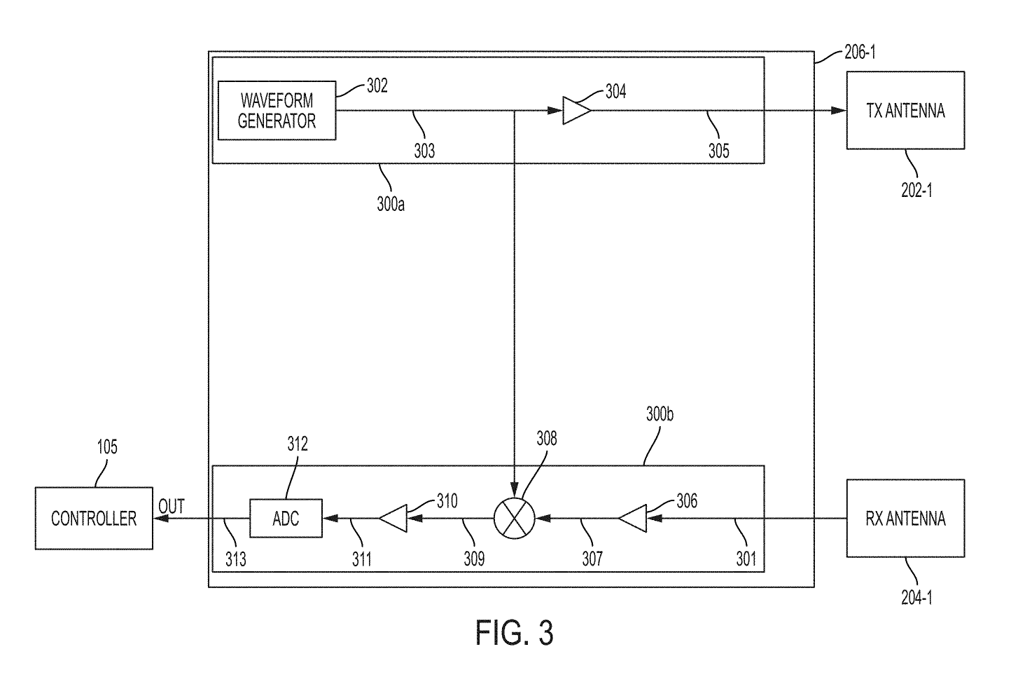

The microwave radar system 100 further comprises RF transceiver units 106, including RF transceiver units 106-1, 106-2, . . . , and 106-8, which are disposed on the support substrate 104. Each of the plurality of RF transceiver units 106 may be configured to transmit and receive microwave RF signals. Some embodiments of RF transceiver units are described below including with reference to FIGS. 2A, 2B, and 3. Although there are eight RF transceiver units shown in the illustrative embodiment of FIG. 1A, other embodiments of microwave radar system 100 may include any other suitable number of RF transceiver units (e.g., two, four, eight, ten, sixteen, twenty five, fifty, one hundred, at least two, at least four, at least eight, at least 16, at least 25, at least 50, between 2 and 100, and between 10 and 1000), as aspects of the technology described herein are not limited by the number of RF transceiver units part of the microwave radar system 100.

In some embodiments, the RF transceiver units 106 may be disposed in a linear arrangement on the support substrate 104, for example, as shown in FIG. 2A. In some instances, the RF transceiver units 106 may be regularly spaced such that the distances between neighboring RF transceiver units are the same or approximately the same (e.g., no more than 1%, 2%, or 5% different). In other instances, the RF transceiver units 106 may be spaced irregularly, such that the distance between two neighboring RF transceiver units is different (e.g., by at least a threshold amount such as at least 5%, 10%, 25%, etc.) from the distance between another two neighboring RF transceiver units.

It should be appreciated that the RF transceiver units 106 are not limited to being arranged linearly on substrate 104. For example, in some embodiments, the RF transceiver units 106 may be arranged in a two-dimensional layout. For example, the RF transceiver units 106 may be arranged in rows and columns. The number of rows and columns may be the same or different. In some embodiments, the number of RF transceiver units in any two rows may be the same, but in other embodiments the number of RF transceiver units in one row (and/or column) may be different from the number of RF transceiver units in a different row (and/or column).

In some embodiments, the support substrate 104 and the focusing element 108 may be arranged on the substrate 102 so that the RF transceiver units 106 may emit microwave RF signals toward the focusing element 108. In this way, RF signals emitted by any one of the RF transceiver units 106 may be focused by the focusing element 108 into a respective RF beam. For example, as shown in the illustrative embodiment of FIG. 1A and in the corresponding side-view of FIG. 1B, the support substrate 104 and the focusing element 108 are arranged on the substrate 102 so that RF signals emitted by each of the RF transceiver units 106 are emitted toward the focusing element 108. In turn, the focusing element 108 focuses RF signals from a particular RF transceiver into a respective RF beam. As one example, focusing element 108 may focus RF signals 110-1 emitted by RF transceiver unit 106-1 into a respective RF beam 112-1. As another example, focusing element 108 may focus RF signals 110-2 emitted by RF transceiver unit 106-2 into a respective RF beam 112-2. As yet another example, focusing element 108 may focus RF signals 110-3 emitted by RF transceiver unit 106-3 into a respective RF beam 112-3.

Accordingly, the RF signals emitted by a particular one of RF transceiver units 106 may be focused into a corresponding RF beam by the focusing element 108. Since each of the RF transceiver units 106 is located at a different position relative to the focusing element 108 (e.g., at a different focal point of the focusing element 108), the RF beams obtained from RF signals generated by different RF transceiver units will irradiate different portions of space from one another. In other words, generating RF signals using one RF transceiver unit (e.g., 106-1) will generate one RF beam focused in one direction and, subsequently, generating RF signals using a different RF transceiver unit (e.g., 106-2) will generate another RF beam focused in another (different) direction. Accordingly, using the RF transceiver units 106 one-at-a-time in some prescribed order to transmit RF signals generates a corresponding sequence of RF beams that may be used to scan an area of interest. The prescribed order may be specified to cause an area of interest to be scanned in a desired fashion (e.g., at different azimuths and/or at different elevations). In this way, the plurality of RF transceiver units 106 may operate as an electronically scanned array—an area of interest is scanned using different RF beams resulting from electronically controlling which one of the RF transceiver units 106 is generating RF signals during a particular time period. Thus, beam steering may be achieved by operating the RF transceiver units 106 one at a time and without requiring that they be phase coherent with one another during operation.

Accordingly, in some embodiments, the RF transceiver units 106 are not driven, concurrently or otherwise, by using signals having relative phases precisely set to generate an RF beam pointing in a desired direction. Instead, in some embodiments, the RF transceiver units 106 may be driven sequentially in a one-at-a-time manner (not concurrently as is the case in a phased array system), and beam steering may be achieved by “optical” means—using a focusing element 108 to generate, for each RF transceiver unit, a respective RF beam pointing in a respective direction, which direction depends on the position of each RF transceiver unit relative to the focusing element. Indeed, one may consider every point on the focusing element 108 as an antenna with a fixed phase offset. Thus, the focusing element 108 may be thought of as a dense fixed set of two-dimensional antennas that are spaced across a larger aperture. Each of the RF transceiver units 106 then operates to sample the focal plane of the focusing element 108 by virtue of emitting RF signals toward the focusing element 108.

In some embodiments, controller 105 may be configured to electronically control the RF transceiver units 106. For example, the controller 105 may be configured to turn each of the RF transceiver units 106 on and off. The controller 105 may be configured to control the RF transceiver units 106 to operate in a one-at-a-time manner by turning each of one or more of the RF transceiver units 106 on and off according to a schedule. The schedule may specify that the RF transceiver units 106 operated according to a time-division multiplexing scheme, whereby only one of the RF transceiver units is transmitting and receiving RF signals in any time slot in the schedule. The schedule may specify the order in which of the RF transceiver units 106 are to be turned on and off (e.g., according to an order of their arrangement and/or any other suitable order). The schedule may further specify how long each of the RF transceiver units is to be on.

In some embodiments, an RF transceiver unit may be configured to transmit different types of RF signals (examples of which are provided herein) and the controller 105 may control the RF transceiver unit to transmit a particular type of RF signal. In some embodiments, controller 105 may obtain RF signals received by one or more of the RF transceiver units 106, process the obtained RF signals (e.g., by performing one or more of downsampling, upsampling, filtering, amplification, modulation, pulse compression, and analog to digital conversion), and provide the processed RF signals to one or more external devices (e.g., external device 107). In other embodiments, controller 105 may obtain RF signals received by one or more RF transceiver units 106 and provide them to one or more external devices without performing any processing.

In some embodiments, controller 105 may be implemented as an application specific integrated circuit (ASIC), a field programmable gate array (FPGA), a combination of logic circuits, a microcontroller, and/or a microprocessor.

In some embodiments, external device 107 may be communicatively coupled to controller 105 (e.g., via connection 117, which may be wired or wireless) and may be configured to receive data from controller 105. For example, external device 107 may be configured to receive, from controller 105, RF signals received by the RF transceiver units disposed on support substrate 104. In some embodiments, the RF signals may be processed by the controller 105 prior to being provided to external device 107.

In some embodiments, external device 107 may be configured to process the received RF signals to identify the range, angle, velocity, and/or acceleration of one or more objects. This may be done in any suitable way using any suitable radar signal processing techniques. For example, when the system 100 is deployed onboard a vehicle (e.g., a car, an unmanned aerial vehicle, a manned aerial vehicle, a vehicle that moves on water, etc.), the external device 107 may be configured to process the RF signals detected by the RF transceiver units 106 to determine whether there are any objects potentially in the path of the vehicle. The external device 107 may further determine, for each object potentially in the path of the vehicle, the distance between the vehicle and the object (i.e., the range to the object) and one or more quantities characterizing the motion of the object such as, for example, the velocity and/or acceleration of the object.

In some embodiments, such information may be used by the person and/or computer(s) controlling the vehicle to avoid any object(s) determined to be in the path of the vehicle. For example, when the vehicle is operated by a human operator (e.g., a human in the vehicle such as a driver of a car or a pilot of an airplane, or a human controlling the vehicle remotely such as a remote operator of a UAV), the vehicle may obtain information from the external device 107 indicating that there is one or more object(s) in the path of the vehicle and may alert the human operator to this possibility (e.g., by using a display, an audio alert, a tactile alert, etc.) so that the human operator may control the vehicle to avoid the object(s). As another example, when the vehicle is operated automatically by a computer using a control algorithm, the control algorithm may use the information obtained from external device 107 to alter the path of the vehicle to avoid the object(s).

In some embodiments, external device 107 may be implemented as an ASIC, an FPGA, a combination of logic circuits, and/or a microprocessor. In some embodiments, the external device 107 may be implemented as a microprocessor that may be programmed with processor-executable instructions to perform the above-described functionality of the external device 107.

In some embodiments, focusing element 108 may comprise a reflector configured to reflect RF signals transmitted by one or more of RF transceiver units 106 toward focusing element 108. In embodiments where the focusing element 108 comprises a reflector, the reflector may have any suitable shape. For example, the reflector may be a truncated parabolic reflector (e.g., as shown in FIG. 1B). As another example, the reflector may be a parabolic reflector that is not truncated (e.g., parabolic reflector 109 shown in FIGS. 1C and 1D). As yet another example, the reflector may be a cylindrical parabolic antenna. As yet another example, the reflector may be designed to achieve a desired RF beam shape. For example, the reflector may be made wider in a given direction so that the resulting beam is narrower in that given direction. For instance, the reflector may have a so-called “orange peel” shape, like the letter “C,” which radiates a narrow vertical fan-shaped beam. The reflector may be made of low-cost metal, metallized plastic, and/or any other material(s) that reflect microwave RF signals.

In other embodiments, the focusing element 108 may comprise a lens such as, for example, a dielectric lens. The lens may be configured to focus RF signals transmitted toward the lens by one or more of RF transceiver units 106. In such embodiments, rather than reflecting the RF signals, as is the case when the focusing element comprises a reflector, the RF signals pass through the lens and the beams are formed on the other side of the lens. For example, FIG. 1F shows an illustrative embodiment of a microwave radar system 125 on a substrate, which comprises a substrate 120 having disposed thereon a support substrate 104, a controller 105, and a dielectric lens 124. As in the embodiment of FIG. 1A, RF transceiver units 106 are disposed on the support substrate 104. The dielectric lens 124 is configured to focus RF signals generated by RF transceiver units 106 into respective RF beams. For example, signals generated by RF transceiver units 106-1, 106-2, . . . , 106-8 may be focused into respective RF beams 116-1, 116-2, . . . , 116-8.

In some embodiments, the focusing element 108 may be configured to generate RF beams having a greater extent in one direction than in another direction. For example, as illustrated in FIG. 1E, the focusing element may be configured to generate RF beams having a greater extent in elevation than in azimuth. In the illustrative example of FIG. 1E, RF signals emitted by RF transceiver unit 106-1 toward focusing element 109 are reflected by reflector 109 and formed into RF beam 127-1 having a greater extent in elevation 121 than in azimuth 123. Similarly, RF signals emitted by RF transceiver unit 106-2 toward focusing element 109 are reflected by reflector 109 and formed into RF beam 127-2 having a greater extent in elevation than in azimuth. RF signals emitted by RF transceiver unit 106-3 toward focusing element 109 are reflected by reflector 109 and formed into RF beam 127-3 having a greater extent in elevation than in azimuth.

In some embodiments, a microwave radar system on a substrate may generate oblong RF beams having a greater extent in elevation than in azimuth for use in collision avoidance applications. When the microwave radar system is installed on a vehicle, operating the RF transceivers 106 in a one-at-a-time manner, will generate a sequence of oblong beams to scan an area at a distance “d” away from (e.g., in front of) the vehicle. As can be seen from the example of FIG. 1E, operating the RF transceiver units 106-1, 106-2, and 106-3, in that order, will generate RF beams 127-1, 127-2, and 127-3, which azimuthally scan an area at a distance d away (e.g., in front of) from the location of the radar system on the vehicle. In some embodiments, the radar system on a substrate may be configured to detect objects at any distance from 100 meters to 1 kilometer away from the vehicle. That is, the radar system on a substrate is configured to detect objects in the far-field regime of the geometric antenna formed by the RF transceiver units and the focusing element. By contrast, if the RF transceivers were merely receivers and received RF energy radiated from a point source in the “near field” (e.g., within 1-10 meters) of the location of the receivers, the resulting system would not be able to perform collision avoidance in the far field regime.

As discussed above, the support substrate 104 and the focusing element 108 may be arranged on the substrate 102 so that the RF transceiver units 106 may emit microwave RF signals toward the focusing element 108. Such an arrangement may be realized in any of numerous ways. For example, the RF transceiver units 106 may be arranged on one side of the support substrate 104 and the support substrate 104 may be mounted on the substrate 102 such that the side with the RF transceiver units 106 is facing the focusing element 108. For example, as shown in FIGS. 1A and 1B, the support substrate 104 may be mounted such that the RF transceiver units on one side of the support substrate 104 are facing the focusing element 108. As can be seen in the side view of system 100 shown in FIG. 1B, support substrate 104 is mounted onto substrate 102 such that RF transceiver unit 106-8 is facing focusing element 108. In this way, RF signals emitted by RF transceiver 106-8 are focused by focusing element 108 (which is a truncated parabolic reflector in this example) into beam 112-8.

In some embodiments, the support substrate 104 and the focusing element may be arranged in an axial relationship, with the support substrate 104 being mounted in front of the focusing element on an axis of symmetry of the focusing element such that the RF transceiver units 106 are pointing toward the focusing element. For example, as shown in the illustrative microwave radar system on a substrate 115 illustrated in FIG. 1C, the support substrate 104 may be mounted in front of (e.g., at the focal point of) the focusing element 109 and along its axis of symmetry 111 by using support structure 114 to raise the support substrate 104 to an appropriate height. Support structure 114 may be made of any suitable material and, in some embodiments, may be made of material (e.g., foam) that does not interfere with the transmission of microwave signals.

In some embodiments, the support substrate 104 and the focusing element may be arranged in an off-axis relationship, with the support substrate 104 being mounted in front of the focusing element but at an angle to the axis of symmetry of the focusing element. In such embodiments, although the RF transceiver units are going to be facing the focusing element, the RF signals transmitted by the RF transceiver units propagate toward the focusing element at an angle to the axis of symmetry of the focusing element. For example, as shown in the illustrative microwave radar system on a substrate 120 illustrated in FIG. 1D, the support substrate 104 may be mounted (in some embodiments, using a support structure 119) at angle so that it emits RF signals toward the focusing element 109 at an angle to the axis of symmetry 111 of focusing element 109. The support structure 119 may be of any suitable type, as aspects of the technology described herein are not limited in this respect.

In some embodiments, including the embodiments described with reference to FIGS. 1A, 1B, 1C, 1E, and 1F, the support substrate 104 is mounted on substrate 102 such that the RF transceiver units on the support substrate 104 face the focusing element and emit RF signals toward the focusing element. However, in some embodiments, the support substrate 104 may be mounted on substrate 102 so that the RF transceiver units on the support substrate 104 are facing away from the focusing element. In such embodiments, an auxiliary reflector may be used to reflect the RF signals emitted by the RF transceiver units back toward the focusing element.

As one example, FIG. 1G shows an illustrative embodiment of a microwave radar system 130 in which the support substrate 104 is mounted on substrate 102 (not shown) such that the RF transceivers 106 are facing away from focusing element 138. System 130 further includes an auxiliary reflector 132 that is a convex hyperboloidal surface. RF signals generated by the RF transceiver units on substrate 104 are emitted toward the auxiliary reflector 132, which redirects them toward focusing element 138. For instance, as shown in FIG. 1G, RF signals generated by the RF transceiver unit 106-1 are emitted toward the auxiliary reflector 132 (in the opposite direction from focusing element 138), which reflects them toward focusing element 138. In the illustrative embodiment of FIG. 1G, focusing element 138 is a parabolic reflector and, as such, the RF signals directed to the focusing element 138 by auxiliary reflector 132 are reflected by the focusing element 138. Though, it should be appreciated that focusing element 138 is not limited to being a parabolic reflector and may be any other suitable type of focusing element including any of the types described herein (e.g., a truncated parabolic reflector, a dielectric lens, etc.). The “Cassegrain” configuration shown in FIG. 1G may have increased aperture efficiency relative to the configurations where the RF transceiver units are facing the focusing element directly.

As another example, FIG. 1H shows an illustrative embodiment of a microwave radar system 135 in which the support substrate 104 is mounted on substrate 102 (not shown) such that the RF transceivers 106 are facing away from focusing element 138. System 130 further includes an auxiliary reflector 134 that is concave ellipsoidal surface. RF signals generated by the RF transceiver units on substrate 104 are emitted toward the auxiliary reflector 134, which redirects them toward focusing element 138. In the illustrative embodiment of FIG. 1H, focusing element 138 is a parabolic reflector and, as such, the RF signals directed to the focusing element 138 by auxiliary reflector 132 are reflected by the focusing element 138. Though, it should be appreciated that focusing element 138 is not limited to being a parabolic reflector and may be any other suitable type of focusing element including any of the types described herein (e.g., a truncated parabolic reflector, a dielectric lens, etc.). The “Gregorian” configuration shown in FIG. 1H also may have increased aperture efficiency relative to the configurations where the RF transceiver units are facing the focusing element directly.

As discussed above, support substrate 104 may be of any suitable type and, in some embodiments, may comprise a printed circuit board. The support substrate 104 may be electrically coupled to one or more components on substrate 102. For example, support substrate 104 may be electrically coupled to controller 105. The support substrate 104 may be coupled to one or more components on substrate 102 in any suitable way. For example, support substrate 104 may comprise one or more connectors, one or more pins (e.g., a pin grid array), a ball grid array, and/or any other suitable means for electrically connecting (and/or mounting) the support substrate 104 on substrate 102.

FIG. 2A is a block diagram of microwave radio-frequency (RF) transceiver units 106-1, 106-2, . . . , and 106-8 disposed on the support substrate 104, in accordance with some embodiments of the technology described herein. Although there are eight RF transceiver units linearly arranged in the embodiment illustrated in FIG. 2A, this is not a limitation of aspects of the technology described herein, as discussed above. For example, in other embodiments, any suitable number of RF transceiver units may be disposed on support substrate 104 and they may be arranged on the support substrate in any suitable way (e.g., in any suitable one-dimensional or two-dimensional arrangement).

In some embodiments, an RF transceiver unit includes at least one transmit antenna, at least one receive antenna, and transceiver circuitry configured to provide, to the at least one transmit antenna, microwave RF signals for transmission by the at least one transmit antenna and to receive, from the at least one receive antenna, microwave RF signals detected by the at least one receive antenna. For example, as shown in FIG. 2A, RF transceiver unit 106-1 includes a transmit antenna 202-1, transceiver circuitry 206-1, and a receive antenna 204-1. Similarly, RF transceiver unit 106-2 includes a transmit antenna 202-2, transceiver circuitry 206-2, and a receive antenna 204-2. RF transceiver unit 106-8 includes a transmit antenna 202-8, transceiver circuitry 206-8, and a receive antenna 204-8. Although each of the RF transceivers shown in FIG. 2A have a single transmit antenna and a single receive antenna, this is not a limitation of aspects of the technology described herein. For example, in some embodiments, an RF transceiver unit may include multiple transmit antennas and a single receive antenna, a single transmit antenna and multiple receive antennas, or multiple transmit antennas and multiple receive antennas.

In some embodiments, including the embodiment illustrated in FIG. 2A, each of the RF transceiver units on the support substrate 104 are designed to be the same (e.g., same number and type of antennas, same placement of antennas, same transceiver circuitry, etc.). In such embodiments, each of the RF transceiver units may be thought of as interchangeable RF “pixels.” Using RF transceiver units having the same design lowers the complexity and cost of designing and manufacturing the microwave RF system on a substrate. However, in some embodiments, a support substrate may include two RF transceiver units having different designs (e.g., two different RF units may have a different number or type of antennas), as aspects of the technology described herein are not limited in this respect.

In some embodiments, an RF transceiver unit may comprise a semiconductor die (chip) and the transceiver circuitry may be integrated on the semiconductor die. For example, as shown in FIG. 2A, RF transceiver unit 106-1 comprises semiconductor die 205-1 and the transceiver circuitry 206-1 is integrated on the semiconductor die 205-1. Similarly, RF transceiver unit 106-2 comprises semiconductor die 205-2 and the transceiver circuitry 206-2 is integrated on the semiconductor die 205-2. RF transceiver unit 106-8 comprises semiconductor die 205-8 and the transceiver circuitry 206-8 is integrated on the semiconductor die 205-8. The semiconductor die may be coupled to support substrate 104 using wire bonding, flip chip bonding, or any other suitable technique for coupling a semiconductor die to the support substrate. The semiconductor die may be a silicon die, for instance from a bulk silicon wafer or silicon-on-insulator (SOI) wafer. In some embodiments, the die may be a single crystal silicon die. In some embodiments, the die may be a CMOS die, a GaN die, or may be formed of any other suitable semiconductor material.

In some embodiments, however, the transceiver circuitry may not be integrated on a semiconductor die and, for example, may be implemented as a collection of discrete components mounted on a PCB (e.g., the support substrate 104). For example, in some embodiments, the discrete components of the transceiver circuitry (e.g., one or more amplifiers, one or more mixers, one or more filters, etc.) may be mounted directly on the PCB.

In some embodiments, where the transceiver circuitry is integrated on a semiconductor die, the transmit antenna(s) and receive antenna(s) may not be integrated on (i.e., are separate from) the semiconductor die. For example, as shown in FIG. 2A, transmit antenna 202-1 and receive antenna 204-1 are not integrated on semiconductor die 205-1. Similarly, transmit antenna 202-2 and receive antenna 204-2 are not integrated on semiconductor die 205-2. Transmit antenna 202-8 and receive antenna 204-8 are not integrated on semiconductor die 205-8. In such embodiments, the transmit antenna(s) and/or receive antenna(s) may be fabricated on the support substrate 104. For example, the support substrate 104 may comprise at least one conductive layer and the transmit and receive antennas may be fabricated on the support substrate 104 by patterning the at least one conductive layer. Alternatively, one or both of the transmit and receive antennas may be manufactured separately and subsequently mounted on the support substrate 104.

In other embodiments, however, the transmit antenna(s), the receive antenna(s), and the transceiver circuitry may all be integrated on a same semiconductor die. For example, as shown in FIG. 2B, transmit antenna 202-1, receive antenna 204-1, and transceiver circuitry 206-1 are all integrated on a semiconductor die 207-1. Similarly, transmit antenna 202-2, receive antenna 204-2, and transceiver circuitry 206-2 are all integrated on a semiconductor die 207-2. Transmit antenna 202-8, receive antenna 204-8, and transceiver circuitry 206-8 are all integrated on a semiconductor die 207-8.

Accordingly, it should be appreciated that, a single RF transceiver unit may be realized in various ways including, but not limited to, the following three ways: (1) all components of the RF transceiver unit are integrated on a single semiconductor die; (2) all components of the RF transceiver unit are connected as discrete components to a printed circuit board (no semiconductor die is used) or (3) some components of the RF transceiver unit are integrated on a single semiconductor die (e.g., the transceiver circuitry) and the semiconductor die together with one or more other components of the RF transceiver unit (e.g., the transmit and receive antennas) are mounted to the printed circuit board. In embodiments where only the transceiver circuitry is integrated on a semiconductor die, but the antennas are not, the semiconductor die may be much smaller in size than either of the antennas. For example, the semiconductor die may be ten percent of the area of the RF transceiver unit.

In some embodiments, an RF transceiver unit may include at least one transmit antenna configured to transmit RF microwave signals in a desired range of frequencies. For example, each of RF transmit antennas 202-1, 202-2, . . . , and 202-8 may be configured to transmit microwave RF signals having a center frequency in a range of 20-25 GHz. As another example, each of RF transmit antennas 202-1, 202-2, . . . , and 202-8 may be configured to transmit microwave RF signals having a center frequency in a range of 60-62 GHz. As another example, each of RF transmit antennas 202-1, 202-2, . . . , and 202-8 may be configured to transmit microwave RF signals having a center frequency in a range of 120-124 GHz. As another example, each of RF transmit antennas 202-1, 202-2, . . . , and 202-8 may be configured to transmit microwave RF signals having a center frequency in a range of 240-248 GHz. It should be appreciated that the above ranges are illustrative and that, in some embodiments, the transmit antenna may be configured to transmit RF microwave signals having any suitable center frequency and/or any suitable frequency content in the microwave band (i.e., 300 MHz-300 GHz).

The receive antenna(s) of an RF transceiver unit may be configured to receive RF microwave signals having a center frequency and/or frequency content in any of the specific frequency ranges described above and/or in any suitable frequency range in the microwave band. For example, each of RF receive antennas 204-1, 204-2, . . . , and 204-8 may be configured to receive microwave RF signals having a center frequency in a range of 20-25 GHz. As another example, each of RF receive antennas 204-1, 204-2, . . . , and 204-8 may be configured to receive microwave RF signals having a center frequency in a range of 60-62 GHz. As another example, each of RF receive antennas 204-1, 204-2, . . . , and 204-8 may be configured to receive microwave RF signals having a center frequency in a range of 120-124 GHz. As another example, each of RF receive antennas 204-1, 204-2, . . . , and 204-8 may be configured to receive microwave RF signals having a center frequency in a range of 240-248 GHz.

The transmit antenna(s) in an RF transceiver unit may be of any suitable type. For example, in some embodiments, a transmit antenna in an RF transceiver unit may be a patch antenna, a MEMS antenna, or a planar spiral antenna. In some embodiments, the transmit antenna may be configured to transmit linearly polarized RF microwave signals. In other embodiments, the transmit antenna may be configured to transmit circularly polarized RF microwave signals. The transmit antenna may be configured to transmit any suitable type of RF signal generated by the transceiver circuitry. Non-limiting examples of such RF signals are described below. In some embodiments, a transmit antenna may transmit anywhere from 5 mW-100 mW of power (e.g., 10 mW of power). The receive antenna(s) in an RF transceiver unit also may be of any suitable type including any of the types described with respect to the transmit antenna. In some embodiments, the transmit and receive antennas may be the same type of antenna.

In embodiments where an antenna (a transmit or receive antenna) in an RF transceiver unit is a patch antenna, the dimensions of the patch antenna depend on the desired range of frequencies in which the antenna is to operate. Illustrative dimensions are provided in Table 1 below. For example, as shown in Table 1, a patch antenna configured to transmit RF signals having a center frequency of 24 GHz (and frequency content in the range 24 GHz±250 MHz) may be sized as a 4.34 mm×3.50 mm antenna. Illustrative dimensions are provided in Table 1 for transmit antennas configured to transmit signals having center frequencies of 61.25 GHz, 122.5 GHz, and 245 GHz. Though, it should be appreciated that patch antennas of other sizes may be used to generate RF signals having any other suitable center frequencies. The range resolution of a single RF transceiver unit depends on the bandwidth of the RF signals transmitted by the transmit antenna in the RF transceiver unit. Table 1 also shows range resolutions associated with respective the bandwidths of the RF signals that may be transmitted by the transmit antenna at different frequency ranges.

TABLE 1
Illustrative dimensions for patch antennas configured to transmit RF
microwave signals having center frequencies in the first column and
bandwidth in the second column. Widths are shown in the third column
and lengths in the fourth column. Range resolutions associated with
the bandwidths of the second column are shown in the fifth column.

| Frequency | Bandwidth | Width | Length | Range Resolution |
|---|---|---|---|---|
| 24 GHz | 250 MHz | 4.34 mm | 3.499 mm | 60 cm |
| 61.25 GHz | 500 MHz | 1.70 mm | 1.34 mm | 30 cm |
| 122.5 GHz | 1 GHz | 0.85 mm | 0.64 mm | 15 cm |
| 245 GHz | 2 GHz | 0.43 mm | 0.29 mm | 7.5 cm |

FIG. 3 is a block diagram of transmit/receive circuitry 206-1 part of a microwave RF transceiver unit 106-1 in a microwave radar system on a substrate, in accordance with some embodiments of the technology described herein. In the illustrative embodiment of FIG. 3, RF transceiver 206-1 includes transmit circuitry 300a and receive circuitry 300b. Transmit circuitry 300a includes waveform generator 302 and amplifier 304. Receive circuitry 300b includes amplifier 306, mixer 308, amplifier 310, and analog-to-digital converter (ADC) 312. Each of amplifiers 304, 306, and 310 may be of any suitable type and may be used to induce any suitable amount of gain to the input RF signals.

In the illustrated embodiment, the output of waveform generator 302 is coupled, via line 303 to amplifier 304. The output of amplifier 304 is coupled, via line 305, to transmit antenna 202-1. Transmit antenna 202-1 may be of any suitable type including any of the types described herein. Accordingly, microwave RF signals generated by waveform generator 302 are amplified by amplifier 304 and provided to the transmit antenna 202-1 to be transmitted by it.

Waveform generator 302 may be any suitable type of waveform generator for generating signals of the type to be transmitted by the RF transceiver unit containing the waveform generator. The waveforms generated by the waveform generator 302 may have any suitable frequencies in the microwave band of 300 MHz to 300 GHz. For example, the waveform generator 302 may be configured to generate RF microwave signals having a center frequency and/or frequency content in the range of 20-25 GHz, 60-62 GHz, 120-124 GHz, 240-248 GHz, or any other suitable range of frequencies in the microwave band.

Waveform generator 302 may be configured to generate any of numerous types of microwave RF waveforms. For example, waveform generator 302 may be configured to generate a chirp waveform. In some embodiments, the chirp may be a linear chirp—a frequency modulated waveform (e.g., a frequency modulated sinusoid) whose instantaneous frequency changes over time. In some embodiments, the chirp may be a non-linear chirp—a frequency modulated waveform (e.g., a frequency modulated sinusoid) whose instantaneous frequency changes non-linearly over time (e.g., geometrically, logarithmically, or in any other suitable way). Additionally or alternatively, waveform generator 302 may be configured to generate frequency-modulated continuous wave RF signals, ultra-wideband RF signals, impulse RF signals, RF signals obtained by modulation of an underlying waveform using Barker codes, linear maximum length (LML) codes, phase codes or other pseudo-random codes, and/or any other suitable type of RF waveform, as aspects of the technology described herein are not limited in this respect.

In the illustrated embodiment, the output of receive antenna 204-1 is coupled, via line 301, to amplifier 306. Receive antenna 204-1 may be of any suitable type including any of the types described herein. The output of amplifier 306 is coupled, via line 307 to one of the inputs of frequency mixer 308. Frequency mixer 308 may be of any suitable type and may be implemented using one or more non-linear elements such as by using one or more diodes. The other input of frequency mixer 308 is coupled to line 303 which provides, to the frequency mixer 308, a copy of the RF signals generated by the waveform generator 302. The output of frequency mixer 308 is coupled, via line 308, to amplifier 310. The output of amplifier 310 is coupled, via line 311, to ADC 312, which may be any suitable type of analog-to-digital converter. The output of ADC 312 is coupled, via line 313, to control circuitry 105. Accordingly, microwave RF signals received by antenna 204-1 are amplified by amplifier 306 and mixed with a copy of the transmitted RF signals by mixer 308. The RF signals output by the mixer 308 are amplified by amplifier 310 and digitized by ADC 312 prior to being provided to controller 105.

It should be appreciated that the transceiver circuitry 206-1 shown in FIG. 3 is illustrative and that there are variations. For example, although in the illustrated embodiment, transceiver circuitry 206-1 includes ADC 312, in other embodiments, an ADC may not be part of the transceiver circuitry. For example, in some embodiments, analog-to-digital conversion may be performed by controller 105 or by external device 107.

Having thus described several aspects some embodiments, it is to be appreciated that various alterations, modifications, and improvements will readily occur to those skilled in the art. Such alterations, modifications, and improvements are intended to be within the spirit and scope of the present disclosure. Accordingly, the foregoing description and drawings are by way of example only.

The above-described embodiments of the present disclosure can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the concepts disclosed herein may be embodied as a non-transitory computer-readable medium (or multiple computer-readable media) (e.g., a computer memory, one or more floppy discs, compact discs, optical discs, magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the present disclosure discussed above. The computer-readable medium or media can be transportable, such that the program or programs stored thereon can be loaded onto one or more different computers or other processors to implement various aspects of the present disclosure as discussed above.

The terms “program” or “software” are used herein to refer to any type of computer code or set of computer-executable instructions that can be employed to program a computer or other processor to implement various aspects of the present disclosure as discussed above. Additionally, it should be appreciated that according to one aspect of this embodiment, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. The functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various features and aspects of the present disclosure may be used alone, in any combination of two or more, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the concepts disclosed herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

What is claimed is:

1. An apparatus, comprising:
a substrate;
a plurality of microwave radio-frequency (RF) transceiver units coupled to the substrate; and
a focusing element mounted on the substrate and configured to focus microwave RF signals generated by the plurality microwave RF transceiver units.

2. The apparatus of claim 1, wherein the plurality of microwave RF transceiver units comprises a first microwave RF transceiver unit, the first microwave RF transceiver unit comprising:
a first transmit antenna configured to transmit microwave RF signals;
a first receive antenna configured to receive microwave RF signals; and
first transceiver circuitry comprising:
first transmit circuitry configured to provide microwave RF signals to be transmitted via the first transmit antenna; and
first receive circuitry configured to receive microwave RF signals from the first receive antenna.

3. The apparatus of claim 2, wherein the first microwave RF transceiver unit comprises:
a semiconductor die,
wherein the first transceiver circuitry is integrated with the semiconductor die.

4. The apparatus of claim 3, wherein the first transmit antenna and the first receive antenna are each integrated with the semiconductor die.

5. The apparatus of claim 2, wherein the first transmit antenna is a patch antenna.

6. The apparatus of claim 2, wherein the first transmit antenna is configured to transmit microwave RF signals having a center frequency in a range of 20-25 GHz.

7. The apparatus of claim 2, wherein the first transmit antenna is configured to transmit microwave RF signals having a center frequency in a range of 60-62 GHz.

8. The apparatus of claim 2, wherein the first transmit antenna is configured to transmit microwave RF signals having a center frequency in a range of 120-124 GHz.

9. The apparatus of claim 2, wherein the first transmit antenna is configured to transmit microwave RF signals having a center frequency in a range of 240-248 GHz.

10. The apparatus of claim 2, wherein the first transmit circuitry comprises:
a waveform generator configured to generate RF signals.

11. The apparatus of claim 10, wherein the waveform generator is configured to generate linear frequency modulated RF signals.

12. The apparatus of claim 10, wherein the waveform is configured to generate frequency-modulated continuous wave RF signals.

13. The apparatus of claim 2, wherein the plurality of microwave RF transceiver units comprises a second microwave RF transceiver unit, the second microwave RF transceiver unit comprising:
a second transmit antenna configured to transmit microwave RF signals;
a second receive antenna configured to receive microwave RF signals; and
second transceiver circuitry comprising:
second transmit circuitry configured to provide microwave RF signals to be transmitted via the second transmit antenna; and
second receive circuitry configured to receive microwave RF signals from the second receive antenna.

14. The apparatus of claim 1, wherein each of the plurality of microwave transceiver units comprises:
a transmit antenna configured to transmit microwave RF signals;
a receive antenna configured to receive microwave RF signals; and
transceiver circuitry comprising:
transmit circuitry configured to provide microwave RF signals to be transmitted via the transmit antenna; and
receive circuitry configured to receive microwave RF signals from the receive antenna.

15. The apparatus of claim 1, wherein the focusing element comprises a reflector.

16. The apparatus of claim 1, wherein the focusing element comprises a lens.

17. The apparatus of claim 1, further comprising:
a controller mounted on the substrate, the controller configured to control individual transceiver units in the plurality of microwave RF transceiver units to operate one-at-a-time according to a schedule.

18. The apparatus of claim 1, wherein in response to receiving an RF signal from one of the plurality of microwave RF transceivers, the focusing element is configured to generate an RF beam having a greater extent in elevation than in azimuth.

19. The apparatus of claim 1, further comprising:
a support substrate mounted on the substrate,
wherein the plurality of microwave RF transceiver units are mounted on the support substrate.

20. The apparatus of claim 18, wherein the support substrate comprises a printed circuit board.

21. An apparatus, comprising:
a substrate;
a plurality of radio-frequency (RF) transceiver units coupled to the substrate; and
a reflector mounted on the substrate and configured to focus microwave RF signals generated by the plurality microwave RF transceiver units.
